(19) United States
(12) Patent Application Publication
(10) Pub. No.: US 2025/0050515 A1
(43) Pub. Date: Feb. 13, 2025

(54) SYSTEMS AND METHODS FOR A VACUUM GRIPPER ASSEMBLY

(71) Applicant: RAM Photonics Industrial, LLC, Webster, NY (US)

(72) Inventor: Michael Cinquino, Conesus, NY (US)

(73) Assignee: RAM Photonics Industrial, LLC, Webster, NY (US)

(21) Appl. No.: 18/798,540

(22) Filed: Aug. 8, 2024

Related U.S. Application Data
(60) Provisional application No. 63/531,764, filed on Aug. 9, 2023.

(51) Int. Cl. B25J 15/06

(52) U.S. Cl. CPC B25J 15/0683

(57) ABSTRACT

Various embodiments of the present disclosure include methods and systems that can be used to grip and translate an optical fiber. A fiber optic positioning and retention system includes a fiber retention mechanism, a fiber alignment block including a first groove extending along a length of the fiber alignment block and at least one aperture passing through the fiber alignment block to the first groove, and at least one chuck positioned within the at least one aperture. The at least one chuck includes a second groove that is aligned with the first groove. The system further includes a vacuum chuck piston coupled to the at least one chuck. A method includes providing the fiber optic positioning and retention system as described above for gripping an optical fiber.

### CROSS-REFERENCES TO RELATED APPLICATIONS

This application claims priority to U.S. Provisional Patent Application No. 63/531,764, filed on Aug. 9, 2023, entitled “Systems and Methods for a Vacuum Gripper Assembly,” the disclosure of which is hereby incorporated by reference in its entirety for all purposes.

### BACKGROUND OF THE INVENTION

Optical fibers have been widely used in optical systems. In some optical systems, multiple optical fibers can be spliced together or an optical fiber can be bonded to an optical element. During the positioning and alignment processes, it may be desirable to accurately grip and translate an optical fiber. However, due to the small size and transparent nature of optical fibers, maintaining alignment of the optical fiber during translation is difficult. Current systems and techniques are often inaccurate, especially when the optical fiber is transported between multiple operations with varying accuracy requirements. Accordingly, there is a need in the art for improved methods and systems related to fiber transportation.

### SUMMARY OF THE INVENTION

The present disclosure relates generally to methods and systems related to optical systems including optical fibers. More particularly, embodiments of the present invention provide methods and systems that can be used to grip and translate an optical fiber. The disclosure is applicable to a variety of applications in lasers and optics, including fiber laser implementations.

In one embodiment, a fiber optic positioning and retention system includes a fiber retention mechanism and a fiber alignment block including a first groove extending along a length of the fiber alignment block and at least one aperture passing through the fiber alignment block to the first groove. The system further includes at least one chuck positioned within the at least one aperture. The at least one chuck includes a second groove that is aligned with the first groove. The system further includes a vacuum chuck piston coupled to the at least one chuck.

The fiber optic positioning and retention system may include various optional embodiments. The at least one chuck may be spring-loaded. The at least one chuck may translate through the at least one aperture of the fiber alignment block. The fiber alignment block may support an optical fiber in a first position relative to the fiber optic positioning and retention system characterized by collinearity of a first apex of the first groove and a center of the optical fiber. The at least one chuck may support the optical fiber in a second position relative to the fiber optic positioning and retention system characterized by collinearity of a second apex of the second groove and the center of the optical fiber. The system may include at least two fiber retention mechanisms. One of the at least two fiber retention mechanisms may be located at each end of the fiber optic positioning and retention system. The vacuum chuck piston may be operable to produce a negative pressure along a length of the first groove and/or the second groove when the vacuum chuck piston is actuated. The negative pressure may be sufficient to grip the optical fiber. The system may further include at least two fiber alignment blocks along a length of the fiber optic positioning and retention system.

In another embodiment, a method of gripping an optical fiber includes providing a fiber optic positioning and retention system. The fiber optic positioning and retention system includes a fiber retention mechanism and one or more fiber alignment blocks. Each of the one or more fiber alignment blocks includes a first alignment surface, a first groove extending along a length of the first alignment surface of the fiber alignment block, and at least one aperture passing through the fiber alignment block to the first groove. The fiber optic positioning and retention system further includes at least one chuck positioned within the at least one aperture. The at least one chuck includes a second groove that is aligned with the first groove and at least one vacuum chuck piston coupled to the at least one chuck. The method further includes positioning the optical fiber within the first groove, actuating the at least one chuck, positioning a second alignment surface of the at least one chuck flush with the first alignment surface of the fiber alignment block, and positioning the optical fiber within the second groove of the at least one chuck. The method also includes actuating the at least one vacuum chuck piston for guiding the optical fiber toward an apex of the second groove, gripping a portion of the optical fiber via the fiber retention mechanism, and retracting the fiber alignment block.

The method of gripping an optical fiber may include various optional embodiments. The optical fiber may be predominantly in a horizontal direction prior to and during the gripping. The method may also include translating, using the fiber optic positioning and retention system, the optical fiber from a first location to a second location. The method may also include placing the optical fiber in a predominantly horizontal direction. The method may also include actuating the at least one chuck within the one or more fiber alignment blocks by transitioning the at least one chuck from a disengaged position to an engaged position. The at least one chuck in the engaged position may contact the optical fiber at one or more surfaces of the second groove. The fiber retention mechanism may maintain contact between the portion of the optical fiber and the fiber retention mechanism as the fiber optic positioning and retention system translates the optical fiber. The method may also include retracting the at least one chuck. The fiber optic positioning and retention system may include at least two fiber retention mechanisms. One of the at least two fiber retention mechanisms may be located at each end of the fiber optic positioning and retention system. The vacuum chuck piston may produce a negative pressure along a length of the first groove and/or the second groove when the vacuum chuck piston is actuated. The negative pressure may be sufficient to grip the optical fiber. The fiber optic positioning and retention system may include at least two fiber alignment blocks along a length of the fiber optic positioning and retention system. The at least one chuck may be spring-loaded.

Numerous benefits are achieved by way of the present disclosure over conventional techniques. For example, embodiments of the present invention enable optical fiber gripping and translation while maintaining accurate alignment. Optical fibers are often transported from one location to another location during processing for which it would be beneficial to maintain a position and/or orientation of the optical fiber across various locations. For example, optical fibers may need to be precisely translated to maximize optical coupling and manufacturing of fiber arrays. Advantageously, embodiments of the present disclosure enable optical fibers to be placed in a horizontal position accurately. In contrast, conventional methods for transporting optical fibers displace the optical fibers vertically as the optical fibers are moved between locations. The fiber optic positioning and retention system described herein advantageously enables both horizontal and vertical alignment of an optical fiber, for example, with respect to a substrate to which the optical fiber is coupled. These and other embodiments of the disclosure, along with many of its advantages and features, are described in more detail in conjunction with the text below and corresponding figures.

### DESCRIPTION OF THE DRAWINGS

FIG. 1 is a perspective view of an embodiment of a fiber optic positioning and retention system as described in the present disclosure.

FIG. 2 is a perspective view of an embodiment of a vacuum alignment assembly as described in the present disclosure.

FIG. 3 is a perspective bottom view of an embodiment of a disengaged vacuum alignment assembly as described in the present disclosure.

FIG. 4 is a perspective bottom view of an embodiment of an engaged vacuum alignment assembly as described in the present disclosure.

FIG. 5A is an end view of an embodiment of an engaged vacuum alignment assembly as described in the present disclosure.

FIG. 5B is an inset of the end view of an embodiment of an engaged vacuum alignment assembly as described in the present disclosure.

FIG. 6 is an end view of an embodiment of a disengaged vacuum alignment assembly as described in the present disclosure.

FIG. 7 is an end view of an embodiment of an engaged vacuum alignment assembly as described in the present disclosure.

FIG. 8 is a flowchart illustrating a method of gripping an optical fiber according to an embodiment of the present disclosure.

### DETAILED DESCRIPTION OF SPECIFIC EMBODIMENTS

Various embodiments of the present disclosure describe a fiber optic positioning and retention system that grips and translates optical fibers accurately. For example, it may be desirable to set an orientation and position of an optical fiber relative to the fiber optic positioning and retention system that is maintained as the optical fiber is moved throughout the system. Stages of processing and/or manufacturing of the optical fiber would benefit from accurate (e.g., known) positioning of the optical fiber as the optical fiber is placed at each location in the system. In addition, at least some embodiments of the present disclosure describe a fiber optic positioning and retention system that is capable of placing the optical fiber in horizontal and vertical positions accurately.

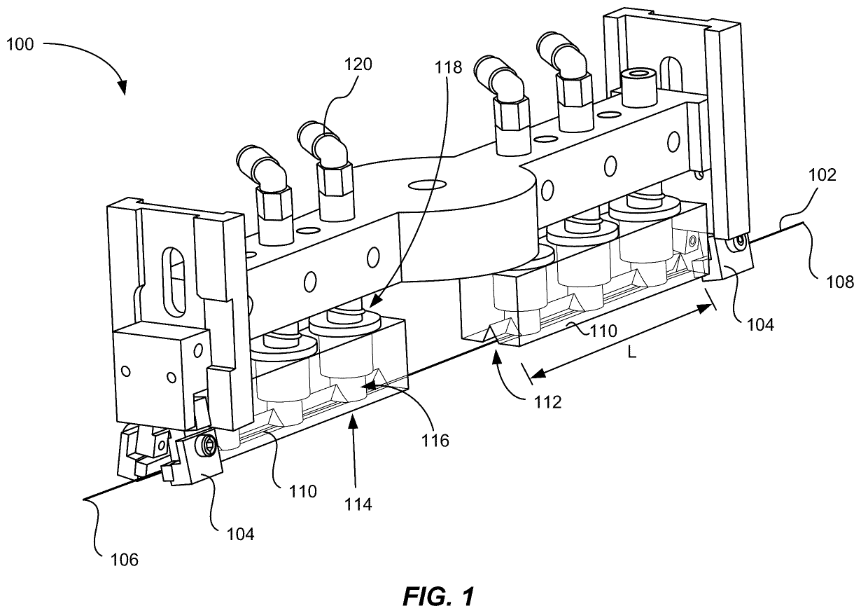

FIG. 1 is a perspective view of an embodiment of a fiber optic positioning and retention system as described in the present disclosure. The fiber optic positioning and retention system 100 is configured to support and maintain an orientation and position of an optical fiber 102 relative to the fiber optic positioning and retention system 100. The orientation and position of the optical fiber 102 may be predefined by a system, manufacturing requirements, etc. The orientation and position of the optical fiber 102 may be verified at various stages in a system by a camera, other image sensor, or other position measuring device, as would be appreciated by one having ordinary skill in the art upon reading the present disclosure.

The fiber optic positioning and retention system 100 includes one or more fiber retention mechanisms illustrated by fiber retention mechanism 104 positioned at opposing ends of the fiber optic positioning and retention system 100. The fiber retention mechanism 104 maintains the optical fiber 102 in the orientation and position relative to the fiber optic positioning and retention system 100 by gripping a portion of the optical fiber 102. In various embodiments, and as illustrated in FIG. 1, the fiber optic positioning and retention system 100 includes a fiber retention mechanism 104 at each end of the fiber optic positioning and retention system 100. Thus, the fiber optic positioning and retention system 100 may include at least two fiber retention mechanisms. For example, a fiber retention mechanism 104 may grip a portion of the optical fiber 102 toward the proximal end 106 of the optical fiber 102 and a fiber retention mechanism 104 may grip a portion of the optical fiber 102 toward the distal end 108 of the optical fiber 102.

The fiber optic positioning and retention system 100 includes one or more fiber alignment blocks as illustrated by fiber alignment block 110. A fiber alignment block 110 includes a first groove 112 extending along a length L of the fiber alignment block 110. A fiber alignment block 110 includes at least one aperture 114 passing through the fiber alignment block 110 to the first groove 112. At least one chuck 116 is positioned within the at least one aperture 114. The at least one chuck 116 is configured to translate through the at least one aperture 114 of the fiber alignment block 110 between an engaged position and a disengaged position. As shown in FIG. 1, the at least one chuck 116 is in the engaged position resulting in contact with the optical fiber 102. In the disengaged position, the at least one chuck 116 is retracted into the fiber alignment block 110. In various embodiments, the at least one chuck 116 is spring-loaded via a spring 118 or other elastic element. In various embodiments, and as illustrated in FIG. 1, the fiber optic positioning and retention system 100 includes a fiber alignment block 110 at each end of the fiber optic positioning and retention system 100. For example, a fiber alignment block 110 may align a portion of the optical fiber 102 toward the proximal end 106 of the optical fiber 102 and a fiber alignment block 110 may align a portion of the optical fiber 102 toward the distal end 108 of the optical fiber 102.

In various embodiments, the fiber optic positioning and retention system 100 includes a vacuum chuck piston 120 coupled to the at least one chuck 116. For example, the vacuum chuck piston 120 is in fluid communication with the least one aperture 114 and the at least one chuck 116. In various embodiments, the at least one chuck 116 includes a channel (not shown) that extends from the vacuum chuck piston 120 to the second groove 404, to be described in detail below with respect to FIG. 4, such that the vacuum chuck piston 120 suction flows through a length of the at least one aperture 114 and a length of the at least one chuck 116. The vacuum chuck piston 120 provides sufficient suction to grip an optical fiber 102 within the first groove 112 and/or the second groove 404, to be described in further detail below with respect to FIG. 4. The vacuum chuck piston 120 is operable to produce a negative pressure along the length of the first groove 112 of the fiber alignment block 110 that is sufficient to grip the optical fiber 102 and guide the optical fiber 102 toward a first apex (e.g., topmost point) of the first groove 112, to be described in further detail below. In some embodiments, each chuck is coupled to a vacuum chuck piston 120. In other embodiments, a vacuum chuck piston 120 is coupled to a plurality of chucks.

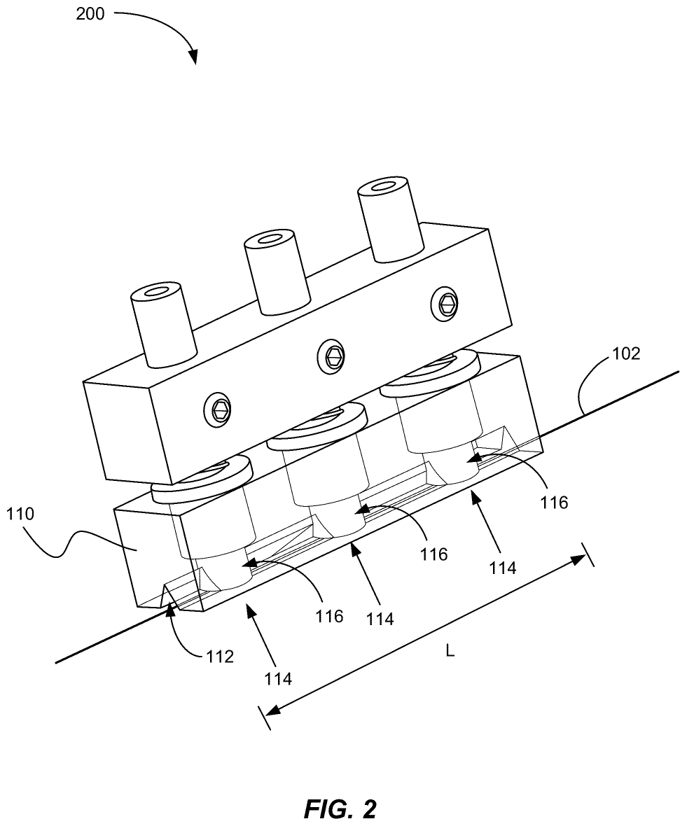

FIG. 2 is a perspective view of an embodiment of a vacuum alignment assembly as described in the present disclosure. FIG. 2 depicts a vacuum alignment assembly 200 having various components removed for clarity, including, but not limited to the fiber retention mechanism(s), the vacuum chuck piston(s), etc. As presently shown in FIG. 2, the vacuum alignment assembly 200 includes a fiber alignment block 110. A fiber alignment block 110 includes a first groove 112 extending along a length L of the fiber alignment block 110. A fiber alignment block 110 includes at least one aperture 114 passing through the fiber alignment block 110 to the first groove 112. At least one chuck 116 is positioned within the at least one aperture 114. The at least one chuck 116 is configured to translate through the at least one aperture 114 of the fiber alignment block 110 between an engaged position and a disengaged position. As shown in FIG. 2, the at least one chuck 116 is in the engaged position resulting in contact with the optical fiber 102. In the disengaged position, the at least one chuck 116 is retracted into the fiber alignment block 110.

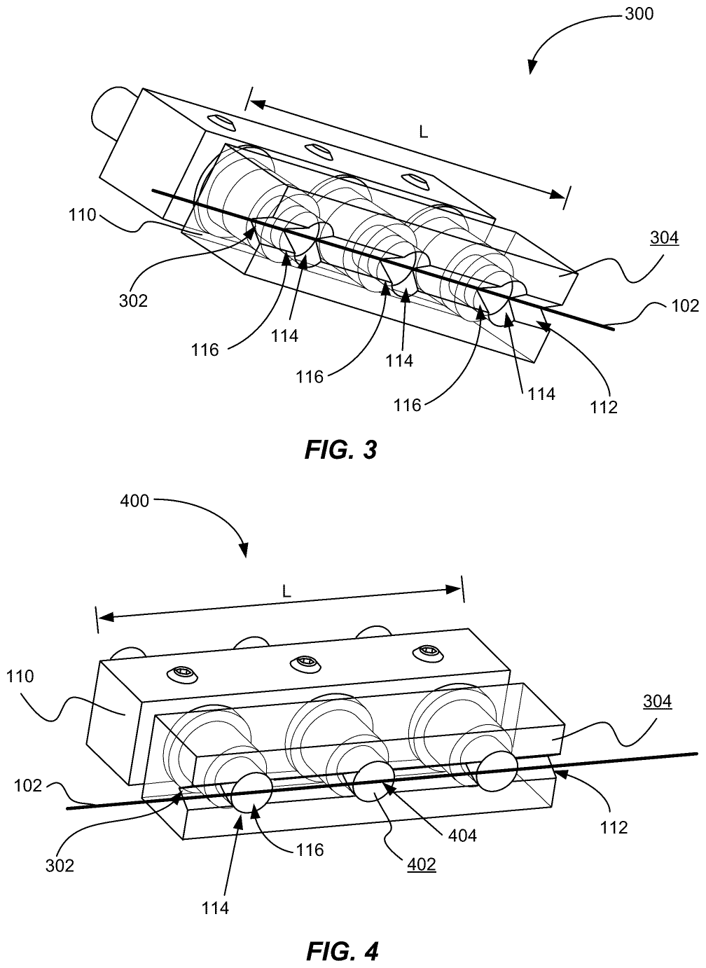

FIG. 3 is a perspective bottom view of an embodiment of a disengaged vacuum alignment assembly as described in the present disclosure. FIG. 3 depicts a vacuum alignment assembly 300 having various components removed for clarity, including, but not limited to the fiber retention mechanism(s), the vacuum chuck piston(s), etc. As presently shown in FIG. 3, the vacuum alignment assembly 300 includes a fiber alignment block 110. A fiber alignment block 110 includes a first groove 112 extending along a length L of the fiber alignment block 110. A fiber alignment block 110 includes at least one aperture 114 passing through the fiber alignment block 110 to the first groove 112. At least one chuck 116 is positioned within the at least one aperture 114. The at least one chuck 116 is configured to translate through the at least one aperture 114 of the fiber alignment block 110 between an engaged position and a disengaged position.

In various embodiments, the fiber alignment block 110 includes a first alignment surface 304. The at least one chuck 116 may translate through the at least one aperture 114 to the first alignment surface 304. A second alignment surface 402 (as shown in FIG. 4) of the at least one chuck 116 may be substantially flush with the first alignment surface 304 of the fiber alignment block 110 when the at least one chuck 116 is engaged, to be described in further detail below. As shown in FIG. 3, the at least one chuck 116 is in the disengaged position since the at least one chuck 116 is retracted into the fiber alignment block 110 and does not make contact with the optical fiber 102.

As illustrated in FIG. 3, the optical fiber 102 has been guided into the first groove 112 and toward a first apex 302 of the first groove 112. The first groove 112 is shown as a v-groove having the bottom of the “v” as the first apex 302 of the first groove. In some embodiments, the first groove 112 may be another shape such as a rounded shape and the topmost point of the rounded shape may be considered the apex. In at least some embodiments, the optical fiber 102 is drawn into the first groove 112 and toward the first apex 302 of the first groove 112 via a vacuum chuck piston coupled to the at least one chuck 116 and disposed in the at least one aperture 114.

FIG. 4 is a perspective bottom view of an embodiment of an engaged vacuum alignment assembly as described in the present disclosure. FIG. 4 depicts a vacuum alignment assembly 400 having various components removed for clarity, including, but not limited to the fiber retention mechanism(s), the vacuum chuck piston(s), etc. As presently shown in FIG. 4, the vacuum alignment assembly 400 includes a fiber alignment block 110. The fiber alignment block 110 includes a first groove 112 extending along a length L of the fiber alignment block 110. A fiber alignment block 110 includes at least one aperture 114 passing through the fiber alignment block 110 to the first groove 112. At least one chuck 116 is positioned within the at least one aperture 114. The at least one chuck 116 is configured to translate through the at least one aperture 114 of the fiber alignment block 110 between an engaged position and a disengaged position.

The at least one chuck 116 includes a second alignment surface 402. The second alignment surface 402 of the at least one chuck 116 includes a second groove 404 that extends across the second alignment surface 402. As shown in FIG. 4, the at least one chuck 116 is in the engaged position since the at least one chuck 116 is in contact with the optical fiber 102. As further illustrated in FIG. 4, the second alignment surface 402 of the at least one chuck 116 may be substantially flush with the first alignment surface 304 of the fiber alignment block 110 when the at least one chuck 116 is engaged. A vacuum chuck piston, such as vacuum chuck piston 120 described and shown with reference to FIG. 1, may be coupled to the at least one chuck 116 and provide sufficient suction to grip an optical fiber 102 within the first groove 112 and/or the second groove 404. In other words, the vacuum chuck piston may provide sufficient suction to hold optical fiber 102 against the first groove 112 and/or the second groove 404.

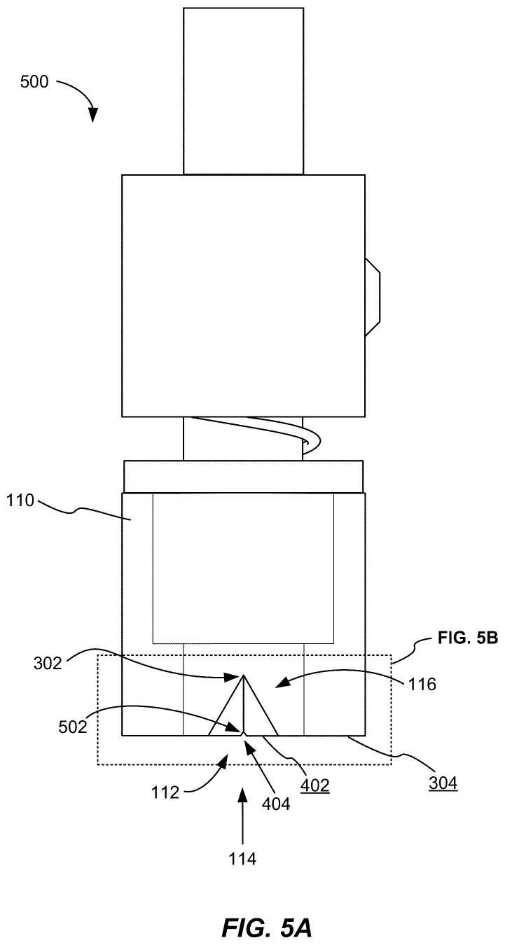

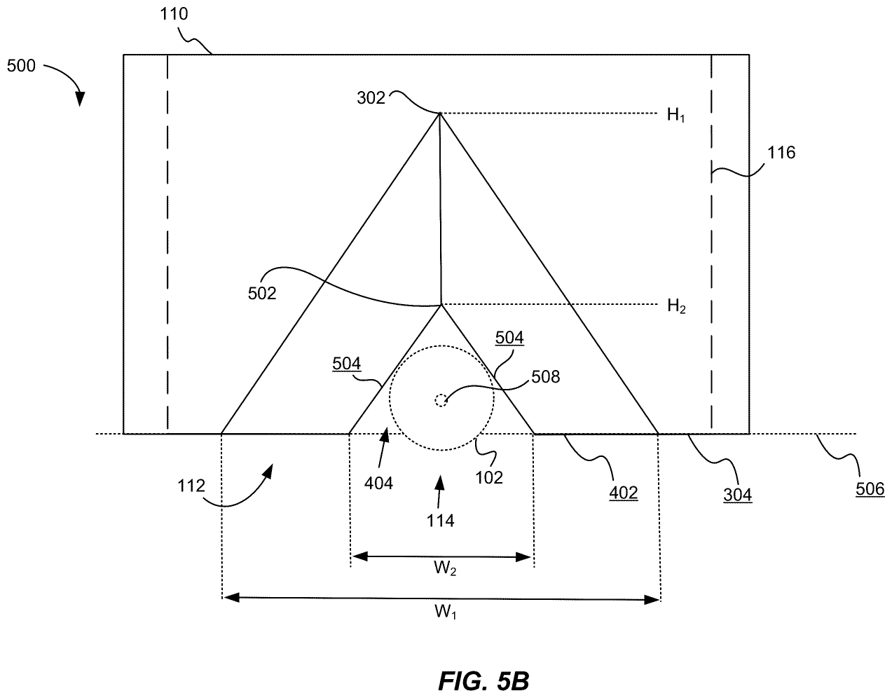

As illustrated in FIG. 4, the optical fiber 102 has been guided into a second apex 502 (shown in FIGS. 5A-5B) of the second groove 404. The second groove 404 may be a v-groove having the bottom of the “v” as the apex of the second groove 404. In some embodiments, the second groove 404 may be another shape such as a rounded shape and the topmost point of the rounded shape may be considered the apex. In at least some embodiments, the optical fiber 102 is drawn into the second groove 404 and toward the second apex 502 (shown in FIGS. 5A-5B) of the second groove 404 via a vacuum chuck piston coupled to the at least one chuck 116 disposed in the at least one aperture 114. In at least some embodiments, the one or more surfaces 504 (shown in FIGS. 5A-5B) of the second groove 404 contact the optical fiber 102 as the at least one chuck 116 is engaged (e.g., translated downward and toward the first alignment surface 304 of the fiber alignment block 110).

FIG. 5A is an end view of an embodiment of an engaged vacuum alignment assembly as described in the present disclosure. FIG. 5A depicts a vacuum alignment assembly 500 having various components removed for clarity, including, but not limited to the fiber retention mechanism(s), the vacuum chuck piston(s), etc. As presently shown in FIG. 5A, the vacuum alignment assembly 500 includes a fiber alignment block 110. A fiber alignment block 110 includes a first groove 112 having a first apex 302. The vacuum alignment assembly 500 includes at least one chuck 116 having a second groove 404 having a second apex 502. The fiber alignment block 110 includes at least one aperture 114 passing through the fiber alignment block 110 to the first groove 112. At least one chuck 116 is positioned within the at least one aperture 114. As shown in FIG. 5A, the at least one chuck 116 is in an engaged position such that the second alignment surface 402 of the at least one chuck 116 is substantially flush with the first alignment surface 304 of the fiber alignment block 110.

FIG. 5B is an inset of the end view of an embodiment of an engaged vacuum alignment assembly as described in the present disclosure. The vacuum alignment assembly 500 includes a fiber alignment block 110 having a first groove 112 having a first apex 302. As shown in greater detail in FIG. 5B, vacuum alignment assembly 500 includes at least one chuck 116 having a second groove 404 having a second apex 502. The second groove 404 includes one or more surfaces 504 that contact at least a portion of the optical fiber 102 when the at least one chuck 116 is in an engaged position as shown in FIG. 5B. In some embodiments, the second groove 404 may be rounded such that the one or more surfaces 504 surround the optical fiber 102 along a continuous surface to support the optical fiber 102.

As further shown in FIG. 5B, the first apex 302 of the first groove 112 has a first height H₁ relative to a plane 506 including the first alignment surface 304. The second apex 502 of the second groove 404 has a second height H₂ relative to the plane 506 including the second alignment surface 402 when the second alignment surface 402 is flush with the first alignment surface 304, as shown in FIG. 5B. The first groove 112 has a first width W₁ and the second groove 404 has a second width W₂. The first height H₁ and the first width W₁ of the first groove 112 are greater than the second height H₂ and the second width W₂ of the second groove 404. For example, the first width W₁ may be less than or equal to 1 cm and the second width W₂ may be less than or equal to 100 μm. The proportion of W₁ to W₂ may depend on a location of the optical fiber to be gripped by the vacuum gripper device described herein. For example, a larger W₁ and W₂ may be used to grip a fiber having a relatively large diameter. In a particular embodiment, the first width W₁ is 12 times the second width W₂. The additional area provided by the relatively larger H₁ and W₁ of the first groove 112 enables a coarse alignment of the optical fiber 102 into the first groove 112 relative the vacuum alignment assembly 500. The smaller area provided by the H₂ and W₂ of the second groove 404 enables a fine alignment of the optical fiber 102 into the second groove 404 relative the vacuum alignment assembly 500. For example, the optical fiber 102 has less space to move once the optical fiber 102 settles into the second groove 404. The incremental nature of the coarse alignment and the fine alignment provided by the first groove 112 and the second groove 404 enables accurate and repeatable alignment of optical fibers that are gripped by a vacuum alignment assembly described herein.

As further detailed in FIG. 5B, a center 508 of the optical fiber 102 is aligned with the first apex 302 and the second apex 502 of the first groove 112 and the second groove 404, respectively. As shown, the optical fiber 102 is in a second position, to be described in further detail below. The second position is characterized by collinearity of the second apex 502 of the second groove 404 of the at least one chuck 116 and a center 508 of the optical fiber 102, as illustrated by FIG. 5B. In both the second position and a first position (not shown), the first apex 302 of the first groove 112 of the at least is also collinear with the center 508 of the optical fiber 102.

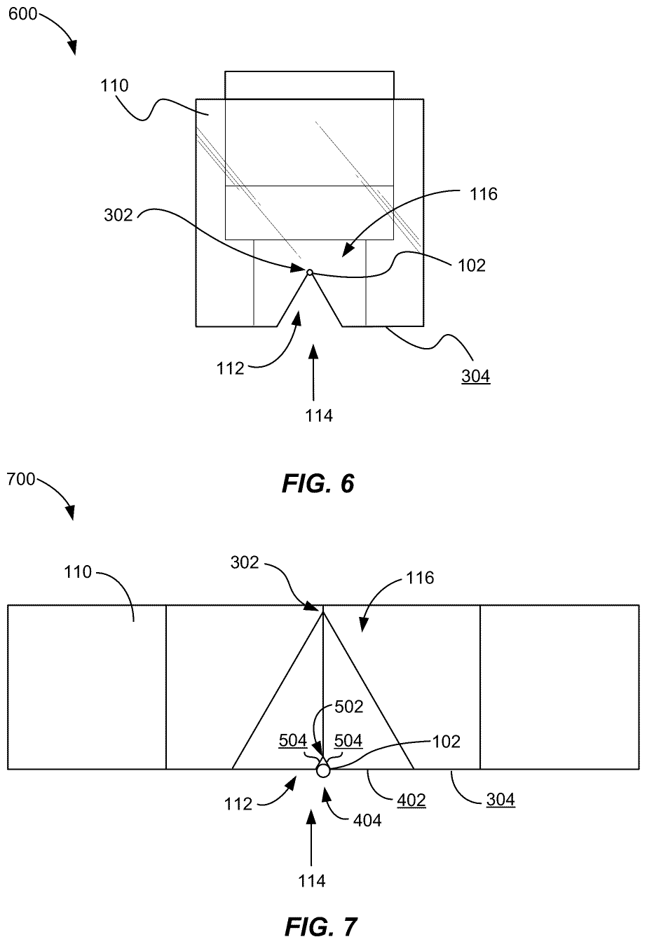

FIG. 6 is an end view of an embodiment of a disengaged vacuum alignment assembly as described in the present disclosure. FIG. 6 depicts a vacuum alignment assembly 600 having various components removed for clarity, including, but not limited to the fiber retention mechanism(s), the vacuum chuck piston(s), etc. As presently shown in FIG. 6, the vacuum alignment assembly 600 includes a fiber alignment block 110. A fiber alignment block 110 includes a first groove 112 having a first apex 302. The fiber alignment block 110 includes at least one aperture 114 passing through the fiber alignment block 110 to the first groove 112. As shown in FIG. 6, the at least one chuck 116 is in a disengaged position such the at least one chuck 116 is retracted within the at least one aperture 114 of the fiber alignment block 110. The fiber alignment block 110 is configured to support an optical fiber 102 in a first position relative to the vacuum alignment assembly 600. The first position is characterized by collinearity of the first apex 302 of the first groove 112 of the fiber alignment block 110 and a center of the optical fiber 102, as illustrated by FIG. 6.

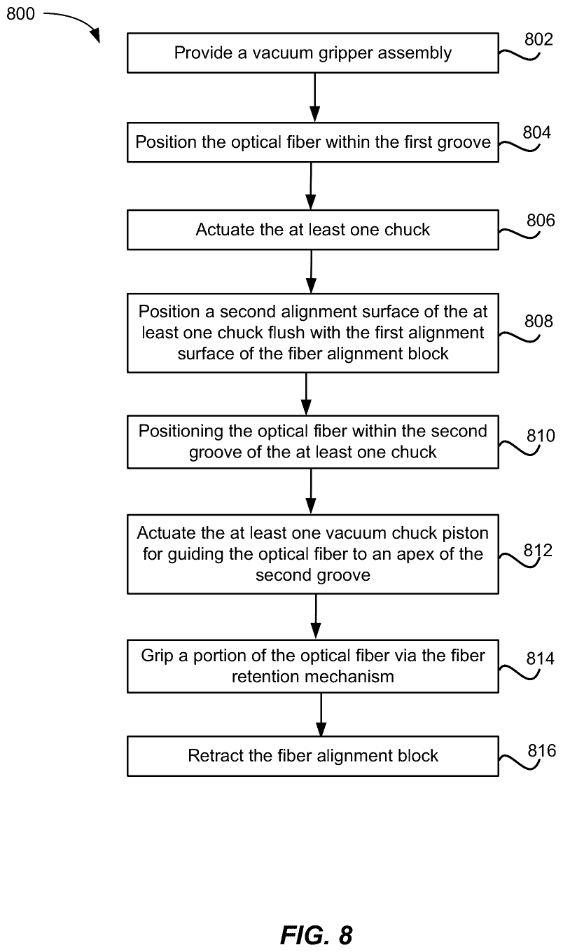

FIG. 7 is an end view of an embodiment of an engaged vacuum alignment assembly as described in the present disclosure. FIG. 7 depicts a vacuum alignment assembly 700 having various components removed for clarity, including, but not limited to the fiber retention mechanism(s), the vacuum chuck piston(s), etc. As presently shown in FIG. 7, the vacuum alignment assembly 700 includes a fiber alignment block 110. The fiber alignment block 110 includes a first groove 112 having a first apex 302. The vacuum alignment assembly 700 includes at least one chuck 116 having a second groove 404 having a second apex 502. The fiber alignment block 110 includes at least one aperture 114 passing through the fiber alignment block 110 to the first groove 112.

As shown in FIG. 7, the at least one chuck 116 is in an engaged position such the second alignment surface 402 of the at least one chuck 116 is flush with the first alignment surface 304 of the fiber alignment block 110. The engaged position of the at least one chuck 116 may be characterized by the at least one chuck 116 contacting the optical fiber 102 along at least a portion of one or more surfaces 504 of the second groove 404. The second apex 502 may be disposed directly above a center (not shown) of the optical fiber 102 or the second apex 502 be in contact with the optical fiber 102, in some embodiments. For example, the second groove 404 may be rounded and the one or more surfaces 504 of the second groove 404 contacts a greater surface area of the optical fiber 102 including the second apex 502, as would be appreciated by one having ordinary skill in the art upon reading the present disclosure. The at least one chuck 116 is configured to support an optical fiber 102 in a second position relative to the vacuum alignment assembly 700. The second position is characterized by collinearity of the second apex 502 of the second groove 404 of the at least one chuck 116 and a center of the optical fiber 102, as illustrated by FIG. 7.

FIG. 8 is a flowchart illustrating a method 800 of gripping an optical fiber according to an embodiment of the present disclosure. Method 800 includes providing a fiber optic positioning and retention system (802). The fiber optic positioning and retention system may include any of the elements and configurations described with respect to FIGS. 1-7. In various embodiments, the fiber optic positioning and retention system includes one or more fiber retention mechanisms. For example, the fiber optic positioning and retention system may include at least two fiber alignment blocks, one fiber alignment block located at each longitudinal end of the fiber optic positioning and retention system. Each of the one or more fiber alignment blocks includes a first groove extending along a length of the fiber alignment block and at least one aperture passing through the fiber alignment block to the first groove. In other words, an aperture extends from a first alignment surface to a surface opposite the fiber alignment block. The fiber optic positioning and retention system also includes at least one chuck positioned within the at least one aperture. The at least one chuck includes a second groove that is aligned with the first groove. The fiber optic positioning and retention system includes a vacuum chuck piston coupled to the at least one chuck. In some embodiments, the vacuum chuck piston may be coupled to plurality of chucks. In other embodiments, each chuck is coupled to a unique vacuum chuck piston. The vacuum chuck piston is operable to produce a negative pressure through the aperture and the at least one chuck. The negative pressure is sufficient to grip the optical fiber when the optical fiber is positioned with the first groove and/or the second groove, to be described in further detail below.

Method 800 includes positioning the optical fiber within the first groove (804). The fiber alignment block includes a first alignment surface having the first groove. The first alignment surface is positioned proximate to the optical fiber and the optical fiber is positioned into the first groove of the first alignment surface by translation of the fiber alignment block (e.g., the fiber optic positioning and retention system having the fiber alignment block) closer to the optical fiber and/or actuation of the vacuum chuck piston that draws the optical fiber into the first groove. In at least some embodiments, the first groove includes a first apex (e.g., a topmost point of a v-groove, a topmost point of a rounded groove, etc.) that supports the optical fiber in a first position. For example, the fiber alignment block is configured to support the optical fiber in a first position relative to the fiber optic positioning and retention system. The first position is characterized by collinearity of a first apex of the first groove and a center of the optical fiber.

Method 800 also includes actuating the at least one chuck (806). The at least one chuck is positioned within the aperture of the fiber alignment block. The at least one chuck is configured to be actuated such that the at least one chuck is translated from within the fiber alignment block to the first alignment surface of the fiber alignment block. Method 800 also includes positioning a second alignment surface of the at least one chuck flush with the first alignment surface of the fiber alignment block (808). For example, the second alignment surface of the at least one chuck may become substantially flush with the first alignment surface of the fiber alignment block when the at least one chuck is actuated. Actuating the at least one chuck may include transitioning the at least one chuck from a disengaged position to an engaged position. In the disengaged position, the at least one chuck is retracted into the fiber alignment block. In the engaged position, following actuating the at least one chuck, the second alignment surface of the at least one chuck is flush with the first alignment surface of the fiber alignment block and/or the optical fiber is positioned in the second groove of the at least one chuck.

Method 800 includes positioning the optical fiber within the second groove of the at least one chuck (810). The at least one chuck includes a second alignment surface having the second groove that is aligned with the first groove. As the at least one chuck is actuated, the second groove is translated downward toward the optical fiber and the optical fiber is guided into position within the second groove. The second groove is substantially smaller than the first groove such that the second groove provides more precise alignment of the optical fiber relative to the fiber optic positioning and retention system.

Method 800 includes actuating the at least one vacuum chuck piston for guiding the optical fiber to a second apex of the second groove (812). The at least one vacuum chuck piston is operable to produce a negative pressure through the aperture and the at least one chuck. The at least one vacuum chuck piston is further operable to produce a negative pressure through the first groove and/or the second groove. The negative pressure is sufficient to grip the optical fiber when the optical fiber is positioned with the first groove and/or the second groove. The at least one chuck is configured to support the optical fiber in a second position relative to the fiber optic positioning and retention system. The second position is characterized by collinearity of a second apex of the second groove and a center of the optical fiber.

Method 800 also includes gripping a portion of the optical fiber via the fiber retention mechanism (814). The fiber retention mechanism maintains the optical fiber in the orientation and position relative to the fiber optic positioning and retention system by gripping a portion of the optical fiber. In various embodiments, the fiber optic positioning and retention system includes a fiber retention mechanism at each end of the fiber optic positioning and retention system. For example, a fiber retention mechanism may grip a portion of the optical fiber toward the proximal end of the optical fiber and a fiber retention mechanism may grip a portion of the optical fiber toward the distal end of the optical fiber.

In various embodiments, the optical fiber is predominantly in a horizontal direction prior to and during the gripping. In other words, the optical fiber may be laying horizontally on a substantially flat surface prior to being selected and gripped by the fiber optic positioning and retention system described herein. The ability to select and grip an optical fiber in a horizontal position is advantageous over other vacuum grippers that are limited to selecting and gripping optical fibers when the optical fibers are predominantly in a vertical direction.

Method 800 also includes retracting the fiber alignment block (816). In various embodiments, the fiber alignment block and/or the at least one chuck are retractable from the optical fiber. Each of the fiber alignment block and the at least one chuck translate away from the optical fiber following the optical fiber being gripped by the fiber retention mechanism. For example, the fiber optic positioning and retention system may support the optical fiber using only the fiber retention mechanism located at each end of the fiber optic positioning and retention system such that a portion between a proximal end and a distal end of the optical fiber is exposed. Accordingly, the optical fiber may be accurately placed into another v-groove at a second location. In various embodiments, the vacuum piston chuck(s) may be deactivated once the optical fiber is gripped by the fiber retention mechanism.

In various embodiments, method 800 further includes translating, using the fiber optic positioning and retention system, the optical fiber from a first location to a second location. In at least some embodiments, the fiber optic positioning and retention system is configured to maintain an orientation and position of the optical fiber relative to the fiber optic positioning and retention system within a predefined tolerance, as the optical fiber is translated between locations. According to at least some embodiments, the fiber retention mechanism maintains contact between the portion of the optical fiber and the fiber retention mechanism as the fiber optic positioning and retention system translates the optical fiber. The fiber retention mechanism may be the only component of the fiber optic positioning and retention system that contacts the optical fiber. In various applications, an optical fiber may be translated between stages of a processing system for manufacturing a fiber array or the like. It would be beneficial to maintain the alignment (e.g., the orientation and position) of the optical fiber relative to the fiber optic positioning and retention system during translating. Method 800 may further include placing the optical fiber in a predominantly horizontal direction. For example, the optical fiber may be placed on a substantially flat surface in a horizontal direction. This is advantageous over other fiber optic positioning and retention system that hold, translate, and place the optical fiber (e.g., on a substrate for forming a fiber array) in a predominantly vertical direction.

It should be appreciated that the specific steps illustrated in FIG. 8 provide a particular method of gripping an optical fiber according to an embodiment of the present invention. Other sequences of steps may also be performed according to alternative embodiments. For example, alternative embodiments of the present invention may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a fiber optic positioning and retention system comprising: a fiber retention mechanism; a fiber alignment block comprising: a first groove extending along a length of the fiber alignment block; and at least one aperture passing through the fiber alignment block to the first groove; at least one chuck positioned within the at least one aperture, the at least one chuck comprising a second groove that is aligned with the first groove; and a vacuum chuck piston coupled to the at least one chuck.

Example 2 is the fiber optic positioning and retention system of example 1, wherein the at least one chuck is spring-loaded.

Example 3 is the fiber optic positioning and retention system of example(s) 1-2, wherein the at least one chuck is configured to translate through the at least one aperture of the fiber alignment block.

Example 4 is the fiber optic positioning and retention system of example(s) 1-3, wherein the fiber alignment block is configured to support an optical fiber in a first position relative to the fiber optic positioning and retention system characterized by collinearity of a first apex of the first groove and a center of the optical fiber.

Example 5 is the fiber optic positioning and retention system of example(s) 1-4, wherein the at least one chuck is configured to support the optical fiber in a second position relative to the fiber optic positioning and retention system characterized by collinearity of a second apex of the second groove and the center of the optical fiber.

Example 6 is the fiber optic positioning and retention system of example(s) 1-5, wherein the vacuum chuck piston is operable to produce a negative pressure along a length of the first groove and/or the second groove when the vacuum chuck piston is actuated, wherein the negative pressure is sufficient to grip the optical fiber.

Example 7 is the fiber optic positioning and retention system of example(s) 1-2, further comprising at least two fiber retention mechanisms, wherein one of the at least two fiber retention mechanisms is located at each end of the fiber optic positioning and retention system.

Example 8 is the fiber optic positioning and retention system of example(s) 1-7, further comprising at least two fiber alignment blocks disposed along a length of the fiber optic positioning and retention system.

Example 9 is a method of gripping an optical fiber, the method comprising: providing a fiber optic positioning and retention system comprising: a fiber retention mechanism; one or more fiber alignment blocks, each of the one or more fiber alignment blocks comprising: a first alignment surface; a first groove extending along a length of the first alignment surface of the fiber alignment block; and at least one aperture passing through the fiber alignment block to the first groove; at least one chuck positioned within the at least one aperture, the at least one chuck comprising a second groove that is aligned with the first groove; and at least one vacuum chuck piston coupled to the at least one chuck; positioning the optical fiber within the first groove; actuating the at least one chuck; positioning a second alignment surface of the at least one chuck flush with the first alignment surface of the fiber alignment block; positioning the optical fiber within the second groove of the at least one chuck; actuating the at least one vacuum chuck piston for guiding the optical fiber toward an apex of the second groove; gripping a portion of the optical fiber via the fiber retention mechanism; and retracting the fiber alignment block.

Example 10 is the method of example 9, wherein the optical fiber is predominantly in a horizontal direction prior to and during the gripping.

Example 11 is the method of example(s) 9-10, further comprising translating, using the fiber optic positioning and retention system, the optical fiber from a first location to a second location.

Example 12 is the method of example(s) 9-11, further comprising placing the optical fiber in a predominantly horizontal direction.

Example 13 is the method of example(s) 9-12, wherein actuating the at least one chuck within the one or more fiber alignment blocks includes transitioning the at least one chuck from a disengaged position to an engaged position.

Example 14 is the method of example(s) 9-13, wherein the at least one chuck in the engaged position contacts the optical fiber at one or more surfaces of the second groove.

Example 15 is the method of example(s) 9-14, wherein the fiber retention mechanism maintains contact between the portion of the optical fiber and the fiber retention mechanism as the fiber optic positioning and retention system translates the optical fiber.

Example 16 is the method of example(s) 9-15, further comprising retracting the at least one chuck.

Example 17 is the method of example(s) 9-16, wherein the fiber optic positioning and retention system comprises at least two fiber retention mechanisms, wherein one of the at least two fiber retention mechanisms is located at each end of the fiber optic positioning and retention system.

Example, 18 is the method of example(s) 9-17, wherein the vacuum chuck piston is operable to produce a negative pressure along a length of the first groove and/or the second groove when the vacuum chuck piston is actuated, wherein the negative pressure is sufficient to grip the optical fiber.

Example 19 is the method of example(s) 9-18, wherein the fiber optic positioning and retention system comprises at least two fiber alignment blocks disposed along a length of the fiber optic positioning and retention system.

Example 20 is the method of example(s) 9-19, wherein the at least one chuck is spring-loaded.

The technology described and claimed herein is not to be limited in scope by the specific preferred embodiments herein disclosed, since these embodiments are intended as illustrations, and not limitations, of several aspects of the technology. Any equivalent embodiments are intended to be within the scope of this technology. Indeed, various modifications of the technology in addition to those shown and described herein will become apparent to those skilled in the art from the foregoing description. Such modifications are also intended to fall within the scope of the appended claims.

What is claimed is:

1. A fiber optic positioning and retention system comprising:
a fiber retention mechanism;
a fiber alignment block comprising:
a first groove extending along a length of the fiber alignment block; and
at least one aperture passing through the fiber alignment block to the first groove;
at least one chuck positioned within the at least one aperture, the at least one chuck comprising a second groove that is aligned with the first groove; and
a vacuum chuck piston coupled to the at least one chuck.

2. The fiber optic positioning and retention system of claim 1, wherein the at least one chuck is spring-loaded.

3. The fiber optic positioning and retention system of claim 1, wherein the at least one chuck is configured to translate through the at least one aperture of the fiber alignment block.

4. The fiber optic positioning and retention system of claim 1, wherein the fiber alignment block is configured to support an optical fiber in a first position relative to the fiber optic positioning and retention system characterized by collinearity of a first apex of the first groove and a center of the optical fiber.

5. The fiber optic positioning and retention system of claim 4, wherein the at least one chuck is configured to support the optical fiber in a second position relative to the fiber optic positioning and retention system characterized by collinearity of a second apex of the second groove and the center of the optical fiber.

6. The fiber optic positioning and retention system of claim 4, wherein the vacuum chuck piston is operable to produce a negative pressure along a length of the first groove and/or the second groove when the vacuum chuck piston is actuated, wherein the negative pressure is sufficient to grip the optical fiber.

7. The fiber optic positioning and retention system of claim 1, further comprising at least two fiber retention mechanisms, wherein one of the at least two fiber retention mechanisms is located at each end of the fiber optic positioning and retention system.

8. The fiber optic positioning and retention system of claim 1, further comprising at least two fiber alignment blocks disposed along a length of the fiber optic positioning and retention system.

9. A method of gripping an optical fiber, the method comprising:
providing a fiber optic positioning and retention system comprising:
a fiber retention mechanism;
one or more fiber alignment blocks, each of the one or more fiber alignment blocks comprising:
a first alignment surface;
a first groove extending along a length of the first alignment surface of the fiber alignment block; and
at least one aperture passing through the fiber alignment block to the first groove;
at least one chuck positioned within the at least one aperture, the at least one chuck comprising a second groove that is aligned with the first groove; and
at least one vacuum chuck piston coupled to the at least one chuck;
positioning the optical fiber within the first groove;
actuating the at least one chuck;
positioning a second alignment surface of the at least one chuck flush with the first alignment surface of the fiber alignment block;
positioning the optical fiber within the second groove of the at least one chuck;
actuating the at least one vacuum chuck piston for guiding the optical fiber toward an apex of the second groove;
gripping a portion of the optical fiber via the fiber retention mechanism; and
retracting the fiber alignment block.

10. The method of claim 9, wherein the optical fiber is predominantly in a horizontal direction prior to and during the gripping.

11. The method of claim 9, further comprising translating, using the fiber optic positioning and retention system, the optical fiber from a first location to a second location.

12. The method of claim 9, further comprising placing the optical fiber in a predominantly horizontal direction.

13. The method of claim 9, wherein actuating the at least one chuck within the one or more fiber alignment blocks includes transitioning the at least one chuck from a disengaged position to an engaged position.

14. The method of claim 13, wherein the at least one chuck in the engaged position contacts the optical fiber at one or more surfaces of the second groove.

15. The method of claim 9, wherein the fiber retention mechanism maintains contact between the portion of the optical fiber and the fiber retention mechanism as the fiber optic positioning and retention system translates the optical fiber.

16. The method of claim 9, further comprising retracting the at least one chuck.

17. The method of claim 9, wherein the fiber optic positioning and retention system comprises at least two fiber retention mechanisms, wherein one of the at least two fiber retention mechanisms is located at each end of the fiber optic positioning and retention system.

18. The method of claim 9, wherein the vacuum chuck piston is operable to produce a negative pressure along a length of the first groove and/or the second groove when the vacuum chuck piston is actuated, wherein the negative pressure is sufficient to grip the optical fiber.

19. The method of claim 9, wherein the fiber optic positioning and retention system comprises at least two fiber alignment blocks disposed along a length of the fiber optic positioning and retention system.

20. The method of claim 9, wherein the at least one chuck is spring-loaded.
